(19) United States
(12) Patent Application Publication
(10) Pub. No.: US 2021/0204580 A1
(43) Pub. Date: Jul. 8, 2021

(54) ORGANIC COMPOUNDS

(71) Applicant: Givaudan SA, VERNIER (CH)

(72) Inventors: Yuangang ZHANG, Cincinnati, OH (US); David POTTS, Cincinnati, OH (US)

(21) Appl. No.: 17/059,465

(22) PCT Filed: May 27, 2019
(86) PCT No.: PCT/EP2019/063604

§ 371 Date: Nov. 29, 2020

Related U.S. Application Data
(60) Provisional application No. 62/677,365, filed on May 29, 2018.

(51) Int. Cl. A23L 27/00; A23J 3/16; A23J 3/14; A23J 3/22; A23L 33/185; A23L 2/66; A23L 2/56

(52) U.S. Cl. CPC A23L 27/84; A23J 3/16; A23J 3/14; A23V 2002/00; A23L 33/185; A23L 2/66; A23L 2/56; A23J 3/227

(57) ABSTRACT

Disclosed is a method of suppressing off-notes of non-animal derived proteins contained in consumables. More particular, the present disclosure relates to the use of ethyl cyclohexanoate and flavor compositions comprising ethyl cyclohexanoate for non-animal derived protein containing consumables.

The present disclosure relates to a method of suppressing off-notes of non-animal derived proteins contained in consumables. More particular, the present disclosure relates to the use of ethyl cyclohexanoate and flavor compositions comprising ethyl cyclohexanoate for non-animal derived protein containing consumables.

The use of non-animal proteins in foodstuffs to replace animal raw materials such as egg or milk, but also meat is becoming increasingly important due to the benefits of protein in the diet. While consumers expect their food and beverage products to have multi-functional benefits, consumers still have high expectations that those products deliver great taste along with efficacy in terms of health benefits. Because each type of protein has its own inherent taste, formulating protein into food and beverage products can produce distinctive tastes perceived as unappealing. For example, products made from plant proteins, e.g., leguminous plants, such as soy or pea, display a flavor profile described as grassy, beany, green, earthy, nutty and/or bitter. Particular off-notes often mentioned in relation to soy protein and pea proteins are beany, soy and bitter attributes. Off-notes often mentioned in relation to potato protein are fishy, green, earthy-musty and bitter attributes.

Accordingly, there remains a need for non-animal proteins and products containing non- animal proteins that exhibit improved flavor with reduced off-notes.

Surprisingly it was found that the addition of ethyl cyclohexanoate to products comprising non-animal proteins makes it possible to provide consumable products with an improved flavor profile due to the suppression or at least reduction of off-notes.

Thus there is provided in a first aspect a consumable comprising non-animal derived protein and ethyl cyclohexanoate.

“Non-animal derived protein” refers to protein preparations made from raw materials including, but not limited to, grain (rice, millet, maize, barley, wheat, oat, sorghum, rye, teff, triticale, amaranth, buckwheat, quinoa); legume or pulses (beans (such as soybean, mung beans, faba beans, lima beans, runner beans, kidney beans, navy beans, pinto beans, azuki beans, and the like), peas (such as green peas, yellow peas, chickpeas, pigeon peas, cowpea, and black-eyed peas and the like), sesame, garbanzo, potatoes, lentils, and lupins); seed and oilseed (black mustard, India mustard, rapeseed, canola, safflower, sunflower seed, flax seed, hemp seed, poppy seed, pumpkin, chia, sesame); nuts (almond, walnut, Brazil, Macadamia, cashews, chestnuts, hazelnuts, pine, pecans, peanuts, pistachio and gingko); algal (kelp, wakame, spirulina, chlorella); mycoprotein and/or fungal protein. In one particular embodiment the non-animal derived protein is selected from bean protein, pea protein, grain protein (e.g. wheat, oat, rice protein), algal protein, and faba protein, and mixtures thereof. In another particular embodiment the non-animal derived protein is selected from soy bean protein, pea protein (e.g. green peas), grain protein (e.g. wheat, oat) and mixtures thereof.

Ethyl cyclohexanoate, sometimes referred to as ethyl cyclohexyl carboxylate (CAS 3289-28-9; FEMA No 3544), is known to occur in various natural oils, for example, in virgin olive oil (see, for example, Reiners et al, J. Agric. Food Chem. 1998, 46, 2754-2763) and rum (see Franitza et al, J. Agric. Food Chem. 2016, 64, 637-645). The compound possess a remarkable low odor threshold of about 1 ppt (Gary R. Takeoka et al, Lebensm.-Wiss. u.-Technol., 24,569-570 (1991).

Surprisingly it was found that the use of ethyl cyclohexanoate around its odor detection threshold, that is about 0.5 ppt (ng/L) to about 20 ppt (ng/L) (including 0.6, 0.7, 0.8, 0.9, 1, 1.5, 2, 2.5, 5, 7.5, 8, 9, 10, 12, 14, 15, 16, 18 ppt (ng/L)), provides the masking of certain off-notes, in particular, off-notes of non-animal derived proteins. The addition of higher concentrations (e.g., 50 ppt or more (such as 75 ppt, 100 ppt, 150 ppt, 175 ppt) provides a significant effect on several off-note attributes, but in addition confers some fruity notes. Depending on the consumable these fruity notes are desired or less desired.

The term “off-note” refers to an unpleasant after taste that develops over time after consumption of consumables. The addition of ethyl cyclohexanoate will block, mask or modify the off-notes and make them less apparent or even unnoticeable. Non-animal proteins will thereby lose in particular their beany, bitter taste, or at least these off-note taste attributes will be less apparent.

Thus there is provided in a further aspect a method of masking off-notes in a consumable containing non-animal derived protein, comprising the step of adding to the consumable an effective amount of ethyl cyclohexanoate.

The required amount of ethyl cyclohexanoate to achieve a noticeable effect, mainly depends on the amounts of non-animal derived protein present in the consumable product. For example, good results were achieved by the addition of up to 20 ppt (e.g. 0.5 ppt to about 15 ppt) of ethyl cyclohexanoate to a consumable comprising about 3 wt % of non-animal derived protein. As another example one may cite meat analogue consumables (e.g., fillets, nuggets, burgers, sausages, “meatballs”, and deli “meats”) comprising about 15-50 wt % (such as 17, 20, 25, 30, 35, 40, 45 wt %) of non-animal derived protein. To such type of consumables comprising high amounts (about 15 wt % to about 50 wt %) of non-animal derived proteins, one may add up to 250 ppt of ethyl cyclohexanoate to achieve good results.

Thus there is provided in a further embodiment a consumable comprising non-animal derived protein and ethyl cyclohexanoate, characterized in that the consumable comprises up to about Ing (including 0.005, 0.01, 0.05, 0.1, 0.25, 0.3, 0.5, 0.5, 0.75 ng) of ethyl cyclohexanoate per 1 gram non-animal derived protein.

Ethyl cyclohexanoate may directly be added to a consumable product comprising non- animal derived proteins, or it may be in an earlier step, be admixed with further food additives, such as flavor agents, stabilizers, emulsifiers, preservatives, gums, starches, dextrines, vitamins and minerals, functional ingredients, salts, antioxidants, sweeteners, and colorants, or it may be in a first step entrapped in a matrix material before admixing to a consumable product.

As matrix material one may use any type of food grade carrier such as maltodextrine (e.g. Maltodextrine with a glucose chain length 19 which is almost flavorless), dextrines, modified starches, sugar alcohols (e.g. mannitol, sorbitol, maltitol, isomalt), sugars (e.g. fructose, lactose, glucose), and mixtures thereof.

Examples of suitable flavor agents include natural flavors, artificial flavors, spices, seasonings, and the like. Exemplary flavor agents include synthetic flavor oils and flavoring aromatics and/or oils, oleoresins, essences, and distillates, and a combination comprising at least one of the foregoing.

Flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yuzu, sudachi, and fruit essences including apple, pear, peach, grape, raspberry, blackberry, gooseberry, blueberry, strawberry, cherry, plum, prune, raisin, cola, guarana, neroli, pineapple, apricot, banana, melon, apricot, cherry, tropical fruit, mango, mangosteen, pomegranate, papaya, and so forth.

Additional exemplary flavors imparted by a flavoring agent include a milk flavor, a butter flavor, a cheese flavor, a cream flavor, and a yogurt flavor; a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

Generally any flavoring or food additive such as those described in “Chemicals Used in Food Processing”, Publication No 1274, pages 63-258, by the National Academy of Sciences, can be used. This publication is incorporated herein by reference.

Flavor compositions are typically admixed to a consumable at 0.01 to 2 wt % (e.g. from about 0.2 wt % to about 1 wt %) based on the consumable. To obtain consumables comprising up to 150 ppt of ethyl cyclohexanoate such a flavor compositions should comprise up to 1500 ppb (pg/L) of ethyl cyclohexanoate.

Thus there is provided in a further embodiment a composition suitable for masking non- animal derived protein off-notes, said composition comprising from about 0.025 ppb to up to about 1500 ppb of ethyl cyclohexanoate and at least one flavor agent.

In one embodiment ethyl cyclohexanoate may be admixed with further off-note maskers and/or flavour systems comprising off-note maskers. Depending on the final product one may, for example, increase the sweetness or saltiness of a product to mask off- notes, such as bitterness. The astringency may be masked by adjusting the pH of the final product, by means well to the skilled person.

In another embodiment one may combine ethyl cyclohexanoate with a flavor system comprising a protein binder, as disclosed in detail in WO2017/037181, the publication being incorporated herein by reference. Protein binders are defined therein as follows:

In one embodiment, a binder is selected based upon its ability to tie up or bind to the protein thus preventing the protein from binding to the flavorant. This ability to bind to the protein and “free-up” the flavorant is determined by a number of factors, including, for example, amino acid profile, protein confirmation, hydrophobicity, time of addition, behavior of protein during processing, type of characterizing flavorant(s) and polarity of flavorant(s). In accordance with one embodiment, the protein binder may include a mixture of at least one terpene and at least one carbonyl compound. In another embodiment, the protein binder may include a mixture of a terpene and two or more carbonyl compounds. In one embodiment, suitable terpenes (isoprenoids and tetraterpenoids) include, but are not limited to, carotenes (such as, for example, alpha-carotene, beta-carotene, gamma-carotene, delta-carotene, lycopene, neurosporene, phytofluene, phytoene), and xanthophylls (such as, for example, canthaxanthin, cryptoxanthin, aeaxanthin, astaxanthin, lutein, rubixanthin); monoterpenes (such as, for example, limonene, perillyl alcohol); sesquiterpenes (such as, for example, caryophyllene, β-caryophyllene, zingiberene); saponins; lipids including: phytosterols, campesterol, beta sitosterol, gamma sitosterol, stigmasterol), tocopherols (vitamin E), and omega -3, -6, and -9 fatty acids (such as, for example, gamma-linolenic acid); triterpenoids (such as, for example, oleanolic acid, ursolic acid, betulinic acid, moronic acid); alpha-pinenes, cis-beta-ocimenes and bisabolenes (such as alpha-bisabolene and gamma-bisabolene. Suitable carbonyl compounds include ketones and aldehydes, including, but are not limited to, acetone, acetyl methyl carbinol, acetophenone, 2-butanone, L-carvone, D-carvone, diacetyl, 2-heptanone, beta-ionone, L-menthone, anisyl acetaone, methyl cyclopentenolone, methyl nonyl ketone, methyl heptenone, 2-nonanone, 2-octanone, 2-pentanone, 2-undecanonen, 4-hydroxy-2,5dimethyl-3(2H)-furanone, nootkatone, tridecanone, tetradecalactone, decalactone, butyrolactone, 2-tridecanone, benzaldehyde, n-butyraldehyde, isobutraldehyde, cinnamic aldehyde, citronellal, decanal, docecenal, hexanal, aldehyde C-12, aldehyde C-8, acetaldehyde, trans-2-hexenal, anisyl aldehyde, trans 2-decenal, cis-3-hexenal and cis-4-heptenal.

According to the present disclosure, the term “consumables” refers to products for consumption by a subject, typically via the oral cavity (although consumption may occur via non-oral means such as inhalation), for at least one of the purposes of enjoyment, nourishment, or health and wellness benefits. Consumables may be present in any form including, but not limited to, liquids, solids, semi-solids, tablets, capsules, lozenges, strips, powders, gels, gums, pastes, slurries, syrups, aerosols and sprays. The term also refers to, for example, dietary and nutritional supplements. Consumables include compositions that are placed within the oral cavity for a period of time before being discarded but not swallowed. It may be placed in the mouth before being consumed, or it may be held in the mouth for a period of time before being discarded.

Broadly, consumables include, but are not limited to, foodstuffs of all kinds, confectionery products, baked products, sweet products, savory products, fermented products, dairy products, beverages, oral care products, nutraceuticals and pharmaceuticals.

Exemplary foodstuffs include, but are not limited to, chilled snacks, sweet and savory snacks, fruit snacks, chips/crisps, extruded snacks, tortilla/corn chips, popcorn, pretzels, nuts, other sweet and savory snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, meat analogues, frozen pizza, chilled pizza, soup, canned soup, dehydrated soup, instant soup, chilled soup, UHT soup, frozen soup, pasta, canned pasta, dried pasta, chilled/fresh pasta, noodles, plain noodles, instant noodles, cups/bowl instant noodles, pouch instant noodles, chilled noodles, snack noodles, dried food, dessert mixes, sauces, dressings and condiments, herbs and spices, spreads, jams and preserves, honey, chocolate spreads, nut-based spreads, and yeast-based spreads.

Exemplary confectionery products include, but are not limited to, chewing gum (which includes sugarized gum, sugar-free gum, functional gum and bubble gum), centerfill confections, chocolate and other chocolate confectionery, medicated confectionery , lozenges, tablets, pastilles, mints, standard mints, power mints, chewy candies, hard candies, boiled candies, breath and other oral care films or strips, candy canes, lollipops, gummies, jellies, fudge, caramel, hard and soft panned goods, toffee, taffy, liquorice, gelatin candies, gum drops, jelly beans, nougats, fondants, combinations of one or more of the above.

Exemplary baked products include, but are not limited to, alfajores, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savory biscuits and crackers, bread substitutes.

Exemplary sweet products include, but are not limited to, breakfast cereals, ready-to-eat (“rte”) cereals, family breakfast cereals, flakes, muesli, other ready to eat cereals, children's breakfast cereals, hot cereals.

Exemplary savory products include, but are not limited to, salty snacks (potato chips, crisps, nuts, tortilla-tostada, pretzels, cheese snacks, corn snacks, potato-snacks, ready-to-eat popcorn, microwaveable popcorn, pork rinds, nuts, crackers, cracker snacks, breakfast cereals, luncheon/breakfast meat analogous (hotdogs, cold cuts, sausage), tomato products, margarine, peanut butter, soup (clear, canned, cream, instant, ultrahigh temperature “UHT”), canned vegetables, pasta sauces.

Exemplary dairy products include, but are not limited to, cheese, cheese sauces, cheese-based products, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, soy milk, coffee whiteners, chilled and shelf-stable desserts, soy-based desserts.

Exemplary beverages include, but are not limited to, flavored water comprising protein, soft drinks, fruit drinks, coffee-based drinks, tea-based drinks, juice-based drinks (includes fruit and vegetable), gel drinks, carbonated or non-carbonated drinks, powdered drinks, alcoholic or non-alcoholic drinks, and ready to drink liquid formulations of these beverages.

Exemplary fermented foods include, but are not limited to, cheese and cheese products, meat and meat products, soy and soy products, fish and fish products, grain and grain products, fruit and fruit products.

In certain embodiments, a beverage composition is provided which includes a high concentration of non-animal derived protein (such as soy protein, pea protein, or mixtures thereof). The total amount of protein may be between about 2% by weight and about 15% by weight, or between about 2% and about 12% by weight, or between about 3% and about 10% by weight, or between about 4% and about 8% by weight, or between about 5% and about 7% by weight, or between about 6.4% to 6.5%, or about 6.4% protein by weight, or greater than 3% by weight, greater than 4% by weight, greater than 5% by weight, or greater than 6% by weight of the high protein beverage composition, or any percentage ranges or specific percentages within these ranges.

The invention is now further described with reference to the following non-limiting examples. These examples are for the purpose of illustration only and it is understood that variations and modifications can be made by one skilled in the art.

### EXAMPLE 1

### Soy Protein Beverage

An aqueous soy protein beverage comprising 3 weight % soy protein (SUPRO® XT 219D by DuPont) and 0.1 weight % xanthan gum was prepared.

Sample A (control): soy protein beverage

Sample B: Sample A+0.5 ppt (ng/L) ethyl cyclohexanoate

Sample C: Sample A+15 ppt (ng/L) ethyl cyclohexanoate

The samples were stored in glass beakers, covered with parafilm, and kept at refrigerated temperature for three days prior to tasting. Immediately before tasting, samples were inverted several times to ensure beverage uniformity.

A trained group of tasters were asked to use 3 ml pipettes to compare the reference control sample with sample B and sample C respectively, and provide comments on which soy attributes were most affected. The results are provided in Table 1 below.

Test Method

Samples were removed from the refrigerator 30 minutes before tasting. Carrot sticks, sour cream, crackers, and filtered water were made available to ensure tasters were adequately rinsing and cleansing palates between samples. During the tasting sessions, a minimum of 10 trained tasters were asked to provide the differences between Sample A compared to Sample B and Sample C respectively. The tasting results were also used to compare tasters' feedback between samples B and C, to indicate potential concentration effects of the compound of interest on beany, soy, and bitter descriptors.

Predefined attributes as previously developed by a trained sensory panel were included on the ballots for soy protein, including “beany,” “soy,” and “bitter”. Sensory attributes and corresponding definitions can be found below.

TABLE 1

| | | Rating | | |
|---|---|---|---|---|
| Sample | Description | beany | soy | bitter |
| A (soy protein) | Beany and soy aromatics; bitter taste | | | |
| B (A + 0.5 ppt) | Less beany, soy, and bitter intensity | − − − | − | − |
| | compared to sample A | | | |
| C (A + 15 ppt) | Less beany, soy, and bitter intensity | − | − − − | − − |
| | compared to sample A | | | |

− − − masking,
− − moderate masking,
− slightly masking

Sensory descriptors of the attributes:

Beany: Chalky, sweet, soy-like aroma associated with tofu and bean curd.

Soy: Aromatics associated with soy proteins including notes of protein, green, vitamin, beany, earthy, and starch.

Bitter: Basic taste sensation associated with substances such as caffeine or quinine diluted in water.

### EXAMPLE 2

### Potato Protein

An aqueous potato protein solution comprising 3 weight % potato protein (Solanic™ 200 by Avebe) was prepared (Sample A). Whereas the Sample A was described as earthy, musty, fishy, bitter, a sample to which 14 ppt of ethyl cyclohexanoate was added, was described as earthy, potato-like, but no fishy, bitter taste attributes have been noticed.

### EXAMPLE 3

### Pea Protein

An aqueous pea protein beverage comprising 3 weight % pea protein (Pisane® C9 by Cosucra) and 0.1 weight % xanthan gum was prepared.

Sample A (control): pea protein beverage

Sample B: Sample A+15 ppt (ng/L) ethyl cyclohexanoate

Sample C: Sample A+30 ppt (ng/L) ethyl cyclohexanoate

The samples were stored in glass beakers, covered with parafilm, and kept at refrigerated temperature for three days prior to tasting. Immediately before tasting, samples were inverted several times to ensure beverage uniformity.

Sample A was described as earthy, musty, green, and astringent. In comparison, Sample B showed lower earthy, musty, green, and astringent notes, with even greater reduction in Sample C, particularly for earthy, musty, and astringent perceptions.

### EXAMPLE 4

### Vegetarian Meatball (Meat Substitute)

TABLE 2

| | Comparison | | Sample A | | Sample B | |
|---|---|---|---|---|---|---|
| | Gram | wt % | Gram | wt % | Gram | wt % |
| Water | 165 | 55 | 163.5 | 54.5 | 163.5 | 54.5 |
| Masking composition A* | — | — | 1.5 | 0.5 | — | — |
| Masking composition B** | — | — | — | — | 1.5 | 0.5 |
| Soy Protein Isolate (1) | 45 | 15 | 45 | 15 | 45 | 15 |
| Wheat Gluten (2) | 45 | 15 | 45 | 15 | 45 | 15 |
| Soya Flakes (3) | 45 | 15 | 45 | 15 | 45 | 15 |
| | 300 | 100 | 300 | 100 | 300 | 100 |

(1) Solae Supro XT 291D by Du Pont
(2) Bob's Red Mill Vital Wheat Gluten 75-80% Protein by Bob's Red Mill
(3) Response 4310 IP by Du Pont
*modified starch comprising 0.32 wt % protein binder as defined in WO2017/037181
**Composition A further comprising 15 ppb ethyl cyclohexanoate (resulting in a final concentration of about 0.18 ng/g protein in the final product)

The meatballs were prepared based on the recipes of Table 2 above as follows. The water was added to a Thermomix together with the Soya flakes and mixed room temperature. After 10 minutes the soy protein isolate and the wheat gluten was added while mixing. At the same time the heater was turned on to 100° C. and the ingredients were mixed until the set temperature of 100° C. was reached and continued for 1 minute.

The compositions were removed and formed into 1 oz (about 28 g) balls. The thus prepared balls were canned for storage.

Sample Evaluation:

The cans were opened and pour into individual small pots and heated on medium in the pot cover with aluminum foil until internal ball temperature reached 165 F (about 74° C.). The meatballs were evaluated by 8-10 trained panelists which were asked to describe the difference between Sample A and the Comparison and between Sample A and Sample B. The results are shown in Table 3 below.

TABLE 3

| | Taste description | | | | |
|---|---|---|---|---|---|
| Samples | Beany | soy | bitter | wheaty | Overall performance |
| Comparison | 5 | 5 | 5 | 3 | |
| Sample A | 3 | 3 | 2 | 2 | ++ |
| Sample B | 0 | 0 | 0 | 0 | +++++ |

Rating overall performance on a scale from no effect (±) to best effect (+++++)
Rating Taste description on a scale from not noticed (0) to very strong (5)

As can be seen from the results above, the beany, soy and bitterness offnotes associated with the soy proteins were completed masked/blocked with a masker composition containing ethyl cyclohexanoate.

1. A consumable comprising non-animal derived protein and least 0.001 ng ethyl cyclohexanoate per 1 gram of non-animal derived protein.

2. The consumable according to claim 1 comprising up to 1 ng ethyl cyclohexanoate per 1 gram of non-animal derived protein.

3. A method of masking off-notes in a consumable containing non-animal derived proteins, comprising the step of adding to the consumable an effective amount of ethyl cyclohexanoate.

4. A masking composition for the masking of non-animal derived protein off-notes comprising ethyl cyclohexanoate.

5. The masking composition according to claim 4 comprising up to 1500 ppb of ethyl cyclohexanoate and at least one flavor agent.

6. The masking composition according to claim 4 comprising at least 0.025 ppb of ethyl cyclohaxamoate.

7. The masking composition according to claim 5 comprising at least 0.025 ppb of ethyl cyclohaxamoate.

8. The consumable according to claim 1 comprising up to 0.75 ng ethyl cyclohexanoate per 1 gram of non-animal derived protein.

9. The consumable according to claim 1 comprising up to 0.5 ng ethyl cyclohexanoate per 1 gram of non-animal derived protein.

10. The consumable according to claim 1 comprising up to 0.25 ng ethyl cyclohexanoate per 1 gram of non-animal derived protein.

11. The consumable according to claim 1 comprising up to 0.1 ng ethyl cyclohexanoate per 1 gram of non-animal derived protein.

12. The consumable according to claim 1 comprising up to 0.01 ng ethyl cyclohexanoate per 1 gram of non-animal derived protein.

13. The method of masking off-notes in a consumable containing non-animal derived proteins according to claim 3, wherein the step of adding to the consumable an effective amount of ethyl cyclohexanoate comprises adding up to 1 ng ethyl cyclohexanoate per 1 gram of non-animal derived protein contained in the consumable.

14. The method of masking off-notes in a consumable containing non-animal derived proteins according to claim 3, wherein the step of adding to the consumable an effective amount of ethyl cyclohexanoate comprises adding up to 0.75 ng ethyl cyclohexanoate per 1 gram of non-animal derived protein contained in the consumable.

15. The method of masking off-notes in a consumable containing non-animal derived proteins according to claim 3, wherein the step of adding to the consumable an effective amount of ethyl cyclohexanoate comprises adding up to 0.5 ng ethyl cyclohexanoate per 1 gram of non-animal derived protein contained in the consumable.

16. The method of masking off-notes in a consumable containing non-animal derived proteins according to claim 3, wherein the step of adding to the consumable an effective amount of ethyl cyclohexanoate comprises adding up to 0.25 ng ethyl cyclohexanoate per 1 gram of non-animal derived protein contained in the consumable.

17. The method of masking off-notes in a consumable containing non-animal derived proteins according to claim 3, wherein the step of adding to the consumable an effective amount of ethyl cyclohexanoate comprises adding up to 0.1 ng ethyl cyclohexanoate per 1 gram of non-animal derived protein contained in the consumable.

18. The method of masking off-notes in a consumable containing non-animal derived proteins according to claim 3, wherein the step of adding to the consumable an effective amount of ethyl cyclohexanoate comprises adding up to 0.01 ng ethyl cyclohexanoate per 1 gram of non-animal derived protein contained in the consumable.
